(19) United States
(12) Patent Application Publication
(10) Pub. No.: US 2025/0285521 A1
(43) Pub. Date: Sep. 11, 2025

(54) SYSTEMS AND METHODS OF FIRE DETECTOR ALARM LATCHING

(71) Applicant: Tyco Fire Products LP, Cranston, RI (US)

(72) Inventors: Luke Charles Giwojna, Coleman, WI (US); Jeffrey R. Timler, Peshtigo, WI (US); Brian L. Counts, Menominee, MI (US)

(73) Assignee: Tyco Fire Products LP, Cranston, RI (US)

(21) Appl. No.: 19/212,209

(22) Filed: May 19, 2025

Related U.S. Application Data
(63) Continuation-in-part of application No. 17/614,661, filed on Nov. 29, 2021.
(60) Provisional application No. 62/855,440, filed on May 31, 2019.
(60) Provisional application No. 63/657,219, filed on Jun. 7, 2024.

(51) Int. Cl. G08B 17/103; A62C 37/40; G08B 5/38

(52) U.S. Cl. CPC G08B 17/103; A62C 37/40; G08B 5/38

(57) ABSTRACT

A fire suppression system includes an interface control module, and an interface module. The interface control module can activate a fire suppressant discharge system in response to receiving a fire detection signal. The interface module is connected with the interface control module and is connected with at least one of a first optical sensor and an interface expansion module. The interface expansion module is configured to connect with a second optical sensor. The first optical sensor and the second optical sensor are configured to detect a fire condition at an area of interest and provide the first detection signal to the interface control module in response to detecting the fire. The interface module includes light emitting devices corresponding to the first optical sensor and the interface expansion module, the light emitting devices configured to display different colors indicating a status of the first optical sensor and the interface expansion module.

### CROSS-REFERENCE TO RELATED APPLICATIONS

The present application is a continuation-in-part of U.S. patent application Ser. No. 17/614,661, filed Nov. 29, 2021, which is a national phase of International Application No. PCT/IB2020/054895, filed May 22, 2020, which claims the benefit of and priority to U.S. Provisional Application No. 62/855,440, filed May 31, 2019. The present application claims the benefit of and priority to U.S. Provisional Patent Application No. 63/657,219, filed Jun. 7, 2024. The entire disclosures of these applications are incorporated herein by reference.

### BACKGROUND

Fire suppression systems can be used to protect an area and objects within the area from fire. Fire suppression systems can be activated manually or automatically in response to an indication that a fire is present nearby.

### SUMMARY

At least one aspect relates to a fire suppression system. The fire suppression system can include a sensor to output a status signal. The fire suppression system can include an interface device that include a light emitting device (LED) and one or more processors to cause, based on the status signal indicating a normal condition, the LED to display a first color of light; cause, based on the status signal indicating a fire condition, the LED to display a second color of light; and cause, based on the status signal indicating a fault, the LED to display a third color of light and to maintain the third color of light subsequent to a change of the status signal from indicating the fault. The fire suppression system can include a controller to output an activation signal based on the status signal indicating the fire condition. The fire suppression system can include an actuator to cause a fire suppressant agent to be outputted to suppress the fire condition based on the activation signal.

At least one aspect relates to a fire suppression system. The fire suppression system can include one or more fire detectors to output a signal to indicate that a fire condition is present. The fire suppression system can include a controller to control operation of one or more actuators to cause a fire suppressant to be outputted to address the fire condition. The fire suppression system can include an interface device that includes one or more processors to receive the signal from the one or more fire detectors, output a first alarm responsive to the signal indicating that the fire condition is present, transmit an alarm signal, along a wired connection with the controller, responsive to receiving the signal from the one or more fire detectors, output a second alarm responsive to an indication that the fire condition is not present. The fire suppression system can include an actuator to cause a fire suppressant agent to be outputted to suppress the fire condition responsive to a control signal from the controller. The interface device can include a plurality of LEDs, each LED of the plurality of LEDs corresponding to an optical sensor of the plurality of optical sensors or to the interface extension device, and one or more processors to determine that a status signal from a given sensor of the plurality of optical sensors or the interface extension device is indicative of a fault state, and latch the LED corresponding to the given sensor or the interface extension device in a color representative of the fault state.

At least one aspect relates to a fire detection system. The fire detection system can include a plurality of optical sensors configured to detect a fire condition. The fire detection system can include an interface device coupled with at least one first sensor of the plurality of optical sensors. The fire detection system can include an interface extension device coupled with the interface device and with at least one second sensor of the plurality of optical sensors

At least one aspect relates to a fire detection system. The fire detection system can include a fire detector to detect a fire condition and output a signal representative of a fire condition being present. The fire detection system can include an alarm device that includes one or more processors. The one or more processors can receive the signal representative of the fire condition. The one or more processors can cause at least one light output device to present, in a first mode associated with the fire condition being present, a first indication of the fire condition. The one or more processors can cause the at least one light output device to present, in a second mode that is subsequent to the first mode and associated with the fire condition not being present, a second indication of the fire condition, the second indication different from the first indication.

The fire detector can include an infrared sensor.

The alarm device can include a communication interface to transmit an indication of the fire condition being present to a controller of a fire suppression system.

The first indication of the fire condition can include a first pattern of light output, and the second indication of the fire condition can include a second pattern of light output.

The one or more processors can be to operate the light output device in the first mode responsive to detecting, based on the signal representative of the fire condition, that the fire condition is present for at least a threshold amount of time.

The one or more processors can be to operate the light output device in the second mode responsive to at least one of: discontinuation of reception of the signal representative of the fire condition from the fire detector; and reception of a signal from the fire detector indicative of the fire condition not being present.

The one or more processors can be to maintain the second indication of the fire condition until at least one of reception of an instruction, from a user input device coupled with the alarm device, to deactivate the second indication, and depowering of the alarm device.

At least one aspect relates to a fire suppression system. The fire suppression system can include one or more fire detectors to output a signal to indicate that a fire condition is present; a controller to control operation of one or more actuators to cause a fire suppressant to be outputted to address the fire condition; and an interface device that includes one or more processors to: receive the signal from the one or more fire detectors; output a first alarm responsive to the signal indicating that the fire condition is present; transmit an alarm signal, along a wired connection with the controller, responsive to receiving the signal from the one or more fire detectors; and output a second alarm responsive to an indication that the fire condition is not present; and an actuator to cause a fire suppressant agent to be outputted to suppress the fire condition responsive to a control signal from the controller.

The one or more processors can perform an electronic latching of the outputting of the second alarm responsive to initiation of the second alarm, the second alarm being different from the first alarm.

The one or more fire detectors can include an infrared sensor, the infrared sensor to output the signal responsive to detecting a flame of the fire condition.

The one or more processors can be to periodically monitor the signal from the one or more fire detectors and transition from the first alarm to the second alarm responsive to detecting a transition in the signal from indicating that the fire condition is present to indicating that the fire condition is not present.

The first alarm can include a first pattern of light output, and the second alarm can include a second pattern of light output having at least a different intensity or a different intermittency than the first pattern of light output.

The one or more processors can be to output the first alarm responsive to detecting, based on the signal, that the fire condition is present for at least a threshold amount of time.

The one or more processors can be to output the second alarm responsive to at least one of: discontinuation of reception of the signal from the fire detector; and reception of a signal from the fire detector indicative of the fire condition not being present.

At least one aspect relates to a method. The method can include receiving, by one or more processors, from a fire detector, a signal representative of a fire condition; presenting, by the one or more processors, a first indication of the fire condition responsive to receiving the signal; and presenting, by the one or more processors, responsive to detecting that the fire condition is not present, a second indication of the fire condition, the second indication different from the first indication.

The method can include detecting, by the one or more processors, that the fire condition is not present responsive to at least one of the signal from the fire detector indicating that the fire condition is not present and the signal from the fire detector being discontinued.

The method can include relaying, by the one or more processors, the signal from the fire detector to a controller coupled with a fire suppression device.

The method can include maintaining, by the one or more processors, presentation of the second indication of the fire condition until at least one of reception of an instruction, from a user input device, to deactivate the second indication, and depowering of the one or more processors.

The method can include presenting, by the one or more processors using a light, the first indication of the fire condition as a first pattern of light output, and the second indication of the fire condition as a second pattern of light output, the second pattern having a different color or intermittency than the first pattern.

The method can include presenting, by the one or more processors, the first indication responsive to detecting that the fire condition is present for at least a threshold amount of time.

At least one aspect relates to a fire suppression system. The fire suppression system can include one or more fire detectors to output a signal to indicate that a fire condition is present. The fire suppression system can include a controller to control operation of one or more actuators to cause a fire suppressant to be outputted to address the fire condition. The fire suppression system can include an interface device that includes one or more processors to receive the signal from the one or more fire detectors. The one or more processors can output a first alarm responsive to the signal indicating that the fire condition is present. The one or more processors can transmit an alarm signal, along a wired connection with the controller, responsive to receiving the signal from the one or more fire detectors. The one or more processors can output a second alarm responsive to an indication that the fire condition is not present. The fire suppression system can include an actuator to cause a fire suppressant agent to be outputted to suppress the fire condition responsive to a control signal from the controller.

At least one aspect relates to a method. The method can include receiving, by one or more processors, from a fire detector, a signal representative of a fire condition. The method can include presenting, by the one or more processors, a first indication of the fire condition responsive to receiving the signal. The method can include presenting, by the one or more processors, responsive to detecting that the fire condition is not present, a second indication of the fire condition, the second indication different from the first indication.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a perspective view of an example of a fire detection and suppression system.

FIG. 2 is a block diagram of an example of a fire detection and suppression system.

FIG. 3 is a top view of an interface device of a fire detection and suppression system.

FIG. 4 is a top view of an example of an interface expansion device of a fire detection and suppression system.

FIG. 5 is a top view of an example of a sensor of a fire detection and suppression system.

FIG. 6 is a schematic diagram of an example of a fire suppressant delivery system.

FIG. 7 is a flow diagram of an example of a method of fire detector alarm latching.

### DETAILED DESCRIPTION

Following below are more detailed descriptions of various concepts related to, and implementations of systems and methods of fire detector alarm latching, such as for providing more reliable indications of fire detections. The various concepts introduced above and discussed in greater detail below can be implemented in any of numerous ways, including in standby operation of air pipes in buildings implementations.

A fire suppression system can include an interface control device (e.g., module), an interface device, and an interface expansion device. The system can also include one or more sensors configured to monitor an area of interest to detect a presence of fire in the area of interest. The sensors can be coupled with corresponding interface expansion devices and/or corresponding interface devices, such as by wired connections. Each interface device and/or interface expansion device can connect with one or more sensors. The interface expansion devices can be connected (e.g., daisy-chained) in series with the interface device. For example, the interface device can connect with a first set of three sensors, and a first interface expansion device. The first interface expansion device can connect with a second set of three sensors and a second interface expansion device. The second interface expansion device can connect with a third set of three sensors.

Each connection between upstream (e.g., sensor) and downstream (e.g., interface) devices can be associated with a corresponding light output device (e.g., light emitting diode (LED)), such as an LED on the interface device.

The light output devices can be activated to provide an alert, such as to notify an operator or a technician regarding various conditions. For example, the light output devices can indicate a normal operating mode of the corresponding sensor or interface expansion device by displaying a green color. The light output devices can indicate that a fire or a fire condition (e.g., flames, smoke, a temperature condition, a rate of change of a temperature condition, etc.) has been detected by one of the corresponding sensors or interface expansion devices by displaying a red color. The light output devices can indicate that a fault has occurred with one of the corresponding sensors or interface expansion devices by displaying a yellow/amber color.

The interface device can latch an output of one or more light output devices, such as in response to receiving a signal indicative of a fire condition from one or more sensors. This can be useful to allow information regarding the fire condition to be presented even after the fire condition is resolved. For example, some sensors, such as infrared sensors, can have sufficiently fast detection (and signaling) times and/or responses, such that the sensors can indicate fire conditions that may be resolved by the time an operator inspects the interface device and/or a location of the fire condition, or the sensors can discontinue indicating that the fire condition is present (e.g., transmit a signal that indicates that the fire condition is no longer present; discontinue transmitting a fire detection signal) by the time the fire condition is resolved. This can make it challenging for fire conditions, faults, or other sources of alerts indicated by the interface device to be identified sufficiently after an event that results in the alerts.

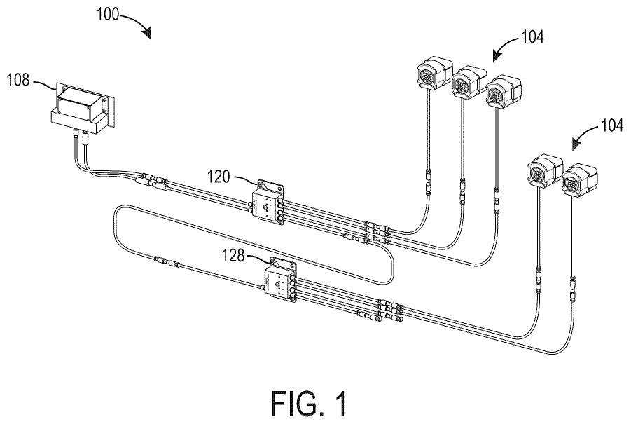

FIG. 1 depicts an example of a system 100, such as a fire detection system and/or a fire suppression system. The system 100 can detect a fire condition (e.g., temperature, heat, smoke, or other indicators of a fire), and can trigger a response to the detected fire condition, such as to output fire suppressant agent at a location of the fire condition to suppress the fire.

The system 100 can detect and/or suppress fires on mobile equipment, commercial vehicles, industrial vehicles, etc. For example, the system 100 can be used on haulers, hydraulic excavators, wheeled loaders, dozers, graders, etc. The system 100 can be used to suppress fire at an engine bay of mobile equipment. For example, the system 100 can be used to suppress fire at an internal combustion engine such as a diesel engine, a gasoline engine, or a compressed natural gas engine. The system 100 can include multiple detection circuits, and can detect fires in multiple areas. The system 100 can detect and suppress fires at or in buildings, sheds, utility closets, houses, kitchen appliances, cookers, fryers, data storage systems, or any other device, apparatus, system, for which fire suppression is useful.

The system 100 can include at least one sensor 104 (e.g., fire detector). The sensors 104 detect an indication of a fire condition, and can output a signal to indicate the fire condition. For example, the sensors 104 can output a signal that indicates the fire condition is present or not present, or can selectively output the signal (such that the presence of the signal indicates the fire condition). The sensors 104 can detect the fire indication of the fire condition by detecting at least one of a temperature, a rate of rise of temperature, heat, a flame, smoke, particulates, and/or electromagnetic signals that correspond to the fire condition. For example, the sensors 104 can include one or more temperature sensors, heat sensors, flame sensors, smoke sensors, particulate sensors, or optical sensors. The sensors 104 can include optical sensors to monitor one or more areas of interest and detect a presence of fire at the one or more areas of interest. The sensors 104 can include optical devices such as photoconductive devices, photovoltaic or solar cells, infrared detectors, photodiodes, phototransistors, optical switches, etc., to detect light intensity and/or light wavelength and generate an electrical signal based on the detected light intensity and/or the light wavelength.

The sensors 104 can include at least one infrared sensor. The infrared sensor can output the indication of the fire condition responsive to detecting infrared information, such as optical infrared information, that corresponds to the fire condition. The infrared sensor can be a flame sensor, such as to detect the fire condition responsive to detecting a wavelength of light corresponding to a flame. The infrared sensor can have a fast response time (e.g., compared with other types of sensors and/or flame detectors), which can result in the infrared sensor rapidly detecting fire conditions (while also rapidly discontinuing an indication of the fire condition). The infrared sensor can output information detected by the infrared sensor (e.g., temperature and/or wavelength information), which can be processed by a receiving device (e.g., controller 108) to detect the fire condition.

The sensors 104 can use a wired communication system, such as RS-485 digital communications, to transmit outputs, such as signals indicating fire conditions and/or statuses of the sensors. The status can include a normal state (e.g., no fault, no alarm, etc.), and a fault or alarm state.

The system 100 can include at least one controller 108. The controller 108 can be an interface control device, such as to control operation of one or more components of a fire suppression system responsive to a received indication of a fire condition. The controller 108 can include one or more processors and memory. The processor can be a general purpose or specific purpose processor, an application specific integrated circuit (ASIC), one or more field programmable gate arrays (FPGAs), a group of processing components, or other suitable processing components. The processor can be configured to execute computer code or instructions stored in memory (e.g., fuzzy logic, etc.) or received from other computer readable media (e.g., CDROM, network storage, a remote server, etc.) to perform one or more of the processes described herein. The memory can include one or more data storage devices (e.g., memory units, memory devices, computer-readable storage media, etc.) configured to store data, computer code, executable instructions, or other forms of computer-readable information. The memory can include random access memory (RAM), read-only memory (ROM), hard drive storage, temporary storage, non-volatile memory, flash memory, optical memory, or any other suitable memory for storing software objects and/or computer instructions. The processor can be implemented as a hardware processor including a Central Processing Unit (CPU), an Application-Specific Integrated Circuit (ASIC), an Application-Specific Instruction-Set Processor (ASIP), a Field Programmable Gate Array (FPGA), a Programmable Logic Device (PLD), a Controller, a Microcontroller unit, a Processor, a Microprocessor, an ARM, or the like, or any combination thereof. The memory can include database components, object code components, script components, or any other type of information structure for supporting the various activities and information structures described in the present disclosure.

The controller 108 can connect with the sensors 104 to detect a presence of a fire or a fire condition, or to predict the likely occurrence of a fire or a fire condition (e.g., at a future point in time). For example, the controller 108 can receive the signal outputted from one or more sensors 104, and can detect the fire condition based on the received signal, such as by comparing one or more values represented by the signal to one or more thresholds representative of the fire condition being present.

The controller 108 can be coupled or with at least one discharge system 208 (e.g., a fire suppressant agent (FSA) discharge system). For example, the controller 108 can be coupled with one or more actuators 212 of the discharge system 42. The controller 108 can receive sensor signals from the sensors 104, and can activate the discharge system 208 based on the received signals, such as to activate the actuators 212. The controller 108 can receive manual activation signals from a manual activation device 204, and can activate the discharge system 208 in response to receiving the manual activation signals. The controller 108 can cause the actuators 212 to cause output of fire suppressant, such as to address a fire condition (e.g., discharge the fire suppressant to suppress the fire, such as according to a given output flow rate, spray area, and/or direction).

The discharge system 208 an include one or more tanks (e.g., reservoirs, containers) to store fire suppressant agent to be discharged. The discharge system 208 can include a plumbing or piping system to fluidly couple the tanks of fire suppressant agent with output devices, such as nozzles, dispersion devices, sprayers, or outlets, to output (e.g., disperse, spread, discharge, provide) the fire suppressant agent to an area of interest, such as a location associated with the fire condition.

The discharge system 208 can include cartridges that store a compressed or expellant gas. The cartridges can be coupled with a corresponding fire suppressant tank. Responsive to the controller 108 providing the actuator(s) 212 with activation signals, the actuator 212 can operate to fluidly couple the cartridge with the corresponding fire suppressant tank. The actuator 212 can be, for example, an electric actuator, a mechanical transducer, an electric pneumatic actuator, or a protracting actuation device. The actuator 212 can puncture a rupture disk to fluidly couple the cartridge with the corresponding fire suppressant tank.

Responsive to the fire suppressant tank being coupled with the cartridge, the expellant or compressed gas can be provided to the fire suppressant tank from the cartridge, thereby pressurizing the fire suppressant agent within the tank. The fire suppressant agent can be forced to flow through the piping or plumbing system to be discharged through the dispersion devices to suppress a fire at the area of interest.

The system 100 can include at least one interface device 120. The interface device 120 can be used to present alerts regarding information received from sensors 104, and can provide data relating to signals from the sensors 104 to the controller 108. For example, the interface device 120 an receive status signals and/or fire detection signals from the sensors. The sensors 104 can have a wired connection with the interface device 120 through cables 224 (e.g., cords, wires, bus cables). For example, the interface device 120 can include a communication interface (e.g., electronic communication interface) to receive the signals from the sensors 104 by way of the wired connection of the cables 224.

In response to receiving an alarm or alert signal from sensors 104, the interface device 120 can convert the received signal to an alarm condition by closing a set of contacts within the interface device 120, which can be read by the controller 108 as an alarm condition. The interface device 120 can be coupled with the controller 108 through the cables 224. The controller 108 can receive signals associated with closing the set of contacts within the interface device 120. A fault condition at the interface device 120 or any connected devices such as sensors 104 (e.g., an open-circuit, a wire-to-ground short, a wire-to-wire short, etc.) can cause a fault relay of interface device 120 to open, which can be read by the controller 108. The controller 108 can report a “Detection Circuit Open Fault” or any other fault message/notification to a user interface device 228 which can be displayed to a user or operator. The interface device 120 and interface expansion device 128 can be constructed to be the same as or similar to each other. The interface device 120 can include power and detection conductors in a single cable.

One or more of the interface device 120, interface expansion device 128, and controller 108 can be an alarm device, such as to output an alarm (e.g., an indication of a fire condition, such as a visual and/or audio alert responsive to detection of the fire condition) based on a signal received from one or more sensors 104. The interface device 120, interface expansion device 128, and/or controller 108 can latch a signal (e.g., a fire detection signal) from the sensors 104 (or from further downstream) subsequent to a threshold amount of time of receipt of the signal from the sensors. As an example, this can be for five seconds or more (e.g., after the signal persists for at least five seconds, or any other predetermined amount of time). For example, the interface device 120 can latch (and can maintain) the signal responsive to a first one of optical sensors 104 detecting a fire condition (e.g., a flame) and then three seconds later a second one of optical sensors 104 detects the fire condition before the detection by the first optical sensor 104 is discontinued, with the total time being greater than five seconds. In such a case, the signal (e.g., the fire detection signal) can be latched or maintained at the interface device 120. Unused interfaces of interface device 120 and/or interface expansion device 128 can be terminated with a plug 220.

Table 1 provides an example of colors that can be displayed by the light output devices of interface device 120 and interface expansion device 128 for various conditions:

TABLE 1
LED Colors and Associated Conditions

| | Color | | |
|---|---|---|---|
| Condition | Green | Amber/Yellow | Red |
| Normal (Stand-by) | X | | |
| Open-Circuit Fault | | X | |
| Wire-to-Ground Fault | | X | |
| Wire-to-Wire Short | | X | |
| Alarm | | | X |

The controller 108, interface device 120, and/or interface expansion device 128 can have a voltage operating range of 9-32 volts DC. This can allow for the circuit accommodating nominal 12 volt and/or 24 volt heavy-duty mobile equipment (HDME) systems. The controller 108, interface device 120, and/or interface expansion device 128 can have an operating temperature range of approximately −40 degrees Celsius to +85 degrees Celsius (or −40 degrees Fahrenheit to 185 degrees Fahrenheit). As an example, the controller 108 can communicably connect with up to three interface devices 120 and interface expansion devices 128 (e.g., one interface device 120 and two interface expansion devices 128). A maximum power circuit length used to power interface device 120 (and/or interface expansion devices 128) can be 200 feet for 12 volt nominal systems, and 300 feet for 24 volt nominal systems. A maximum cable length between sensors 104 and a corresponding interface device 120 and/or interface control device 128 can be 200 feet for 12 and 24 volt nominal systems. A maximum length of cable (e.g., bus cable 224) between interface devices 120 (and interface expansion devices 128) can be 100 feet for 12 volt nominal systems and 250 feet for 24 volt nominal systems.

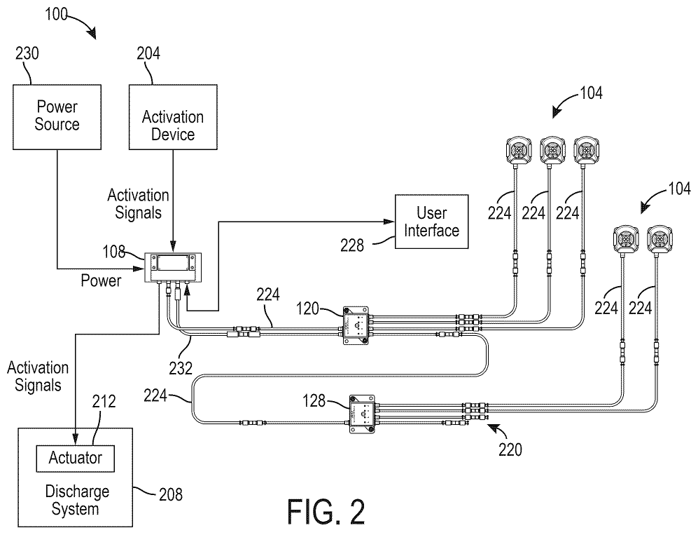

As depicted in FIGS. 1 and 2, the interface device 120 can receive a signal representative of the fire condition from the one or more sensors 104. The interface device 120 can detect the fire condition based on the received signal. For example, the signal can indicate that the fire condition is present, or the interface device 120 can compare one or more values of the signal to one or more thresholds that indicate that the fire condition is present to detect the fire condition.

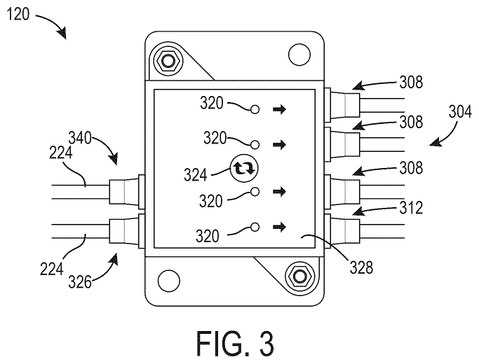

The interface device 120 can present (e.g., using light output devices 320 described with reference to FIG. 3) one or more indications of the fire condition, such as to indicate that the fire condition is present and/or has been detected by the sensors 104. The interface device 120 can control the one or more indications, such as to control a state of light output by the light output devices 320, according to a state of the fire condition represented by the signal from the one or more sensors 104 (or the signal not being present). For example, the interface device 120 can determine that the signal indicates a first state of the fire condition being present, and can present a first indication of the fire condition, e.g., in a first mode corresponding to the first state. The interface device 120 can determine that the signal (or lack of signal) indicates a second state of the fire condition not being present, and can present a second indication of the fire condition, e.g., in a second mode corresponding to the second state (e.g., the second mode being associated with the fire condition not being present).

The interface device 120 can present the second indication subsequent to the first indication, such as to transition from the first indication to the second indication responsive to the interface device 120 determining that the fire condition detected by the sensors 104 is not present (e.g., post-alarm state). This can allow the interface device 120 to continue to provide an alert regarding fire conditions that may be highly transient, e.g., due to the rapid detection capabilities of infrared sensors 104. For example, this can allow the interface device 120 to continue to provide the alert even after the fire condition has ended or been suppressed by the discharge system 208 (without which it may not be possible for a user of the system 100 to discern the location of the fire condition, distinguish faults from alarms, or troubleshoot faults and alarms). For example, this can allow the interface device 120 to not rely on wireless communication electronics for alert communication, which can save size, weight, and/or power for operation of the interface device 120; similarly, the use of the light output devices 320 and the latching of the light output devices 320 in the second mode can allow for greater reliability in ensuring that the indication of the fire condition is provided. For example, the interface device 120 can monitor (e.g., periodically sample and/or process) the signal from the one or more sensors, detect that the fire condition is present, and can cause the first indication of the fire condition to be presented responsive to detecting that the fire condition is present. The interface device 120 can (continue to) monitor for the fire condition responsive to presenting the first indication, and can update the presented indication responsive to detecting a change in the fire condition, such as to detect that the fire condition is not present or no longer present. For example, to update the presented indication, the interface device 120 can switch from the first indication to the second indication. Various such features described with reference to the interface device 120 can be performed using the controller 108 and/or interface expansion device 128.

The interface device 120 can operate in the first mode, e.g., initiate output of the first indication, responsive to detecting that the fire condition is present for at least a threshold amount of time (e.g., on the order of seconds or minutes). For example, the interface device 120 can start a timer responsive to detecting the fire condition, and trigger the output of the first condition responsive to the timer exceeding the threshold amount of time (or reset the timer responsive to the fire condition not being present before the threshold amount of time is exceeded).

The interface device 120 can determine to operate in the second mode responsive to one or more conditions, such as one or more conditions that indicate that the fire condition is no longer present. For example, the interface device 120 can determine to operate in the second mode responsive to discontinuation of reception of the signal from the sensor 104. The interface device 120 can determine to operate in the second mode responsive to receiving a signal from the sensor 104 that indicates that the fire condition is not present.

The interface device 120 can latch the output (e.g., latch operation of the light output devices 320, such as to maintain the operation in the first mode and/or the second mode) until a discontinuation condition is satisfied. For example, the interface device 120 can maintain the second indication of the fire condition until receipt of an instruction from a user interface (e.g., from reset button 324) to discontinue presenting the second indication, such as to deactivate the light output device(s) 320 that are presenting the second indication. The interface device 120 can deactivate the light output device(s) 320 responsive to depowering of the interface device 120 (or responsive to a change in a power state of the interface device 120 associated with instructions to discontinuing the second indication).

The first indication and the second indication can have one or more different characteristics of light output. The characteristics can include one or more of a light intensity, a light color, an intermittency, or a pattern. For example, the first indication can include a first color, and the second indication can include a second color. The first indication can include a first intermittency or pattern, such as to present the alarm as a flashing light, and the second indication can include a second intermittency or pattern, such as to present the alarm as a solid light (or vice versa).

As depicted in FIG. 3, the interface device 120 can include a connector 304. The connector 304 can connect with sensors 104 and interface expansion device 128. The connector 304 can be a female bus connector pigtail assembly. The connector 304 can receive and connect with bus cables 224. The connector 304 can include sensor input connectors 308 and can include expansion input connector 312. The sensor input connectors 308 and expansion input connector 312 can couple with a same type of cable (e.g., bus cable 224). The sensor input connectors 308 can receive and can couple with bus cables 224 of corresponding sensors 104. The expansion input connector 312 can receive and can couple with bus cable 224 of a corresponding interface expansion device 128. The interface device 120 can include light output devices 320 that correspond to each connected bus cable 224 (e.g., three sensors 104 and interface expansion device 128). The light output devices 320 can operate to display any of various colors, such as, for example, to display red, green, or yellow/amber color.

The interface device 120 can include a reset button 324. The reset button 324 can be used to reset output of alerts and/or alerts by the interface device 120. For example, the reset button 324 can cause the interface device 120 to discontinue a latching of output of the at least one of the first indication and the second indication by the light output devices 320.

The interface device 120 can include an enclosure 328 (e.g., a housing, a container, a mold, a shell, a body, etc.) to enclose internal components of the interface device 120. For example, the enclosure 328 can enclose switches, relays, processors, processing circuits, memory, PCB boards, etc., of the interface device 120. The enclosure 328 can be filled with a resin to seal against environmental factors, thereby protecting internal components of interface device 120.

The interface device 120 can include a power connector 326. The power connector 326 can receive power through a corresponding power cable 232 to power interface device 120. The interface device 120 can receive power from the power source 230 through the power cable 232 and power connector 326. The power cable 232 can connect directly to a battery (e.g., a vehicle battery, power source 230) via a fused power cable, or can connect to a power output of controller 108 (as shown in FIGS. 1-2).

The interface device 120 can include a detection connector 340. The detection connector 340 can receive a corresponding detection cable 224 to connect the interface device 120 with controller 108.

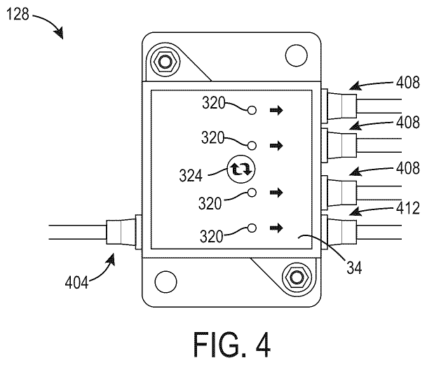

As depicted in FIG. 4, the interface expansion device 128 can include both input power and detection in a single cable, shown as connector 404. A cable the same as or similar to bus cable 224 can communicably and electrically couple interface expansion device 128 with interface device 120. The interface expansion device 128 can provide interface device 120 with signals received from sensors 104 that are downstream of the interface expansion device 128. For example, the interface expansion device 128 can receive fault or alarm signals from sensors 104 that are connected through sensor input connectors 408 and provide any of the fault or alarm signals to interface device 120 through connector 412. The interface expansion device 128 can also receive power from the interface device 120 through the connector 412.

The interface expansion device 128 can include the light output devices 320 and reset button 324. Light output devices 320 can operate to periodically and/or continuously display light outputs indicative of alarm and/or fault conditions, such as the amber/yellow color in response to a fault in one of sensors 104 (or a further downstream interface expansion device 128) until the reset button 324 is pressed for a predetermined time duration (e.g., 3 seconds). Responsive to the interface expansion device 128 receiving a fault (e.g., an intermittent fault signal) from one of sensors 104 or from a further downstream interface expansion device 128, the interface expansion device 128 can provide the interface device 120 with a fault signal through the connector 412 and the corresponding cable. The interface device 120 can receive the fault signal through the corresponding cable and the expansion input connector 312. The interface device 120 can operate the corresponding light output devices 320 responsive to the received signal.

Additional interface expansion devices 128 can be daisy-chained in series such that additional sensors 104 can be integrated into the system 100. In this way, the signals generated by sensors 104 can be provided to controller 108.

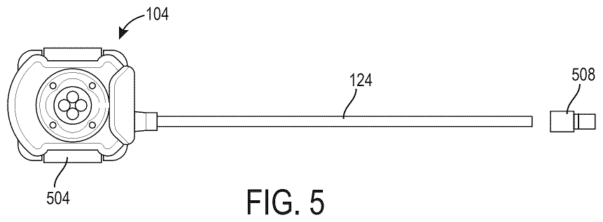

FIG. 5 depicts an example of the sensor 104. The sensors 104 can be infrared optical sensors to monitor an area of interest for fire detection. The sensor 104 can include an enclosure 504. The enclosure 504 can enclose internal components (e.g., processing circuit, PCB boards, processors, microprocessors, etc.) of the sensor 104. The internal components (e.g., the PCB board) of sensor 104 can be communicably connected with a corresponding interface device 120 and/or interface expansion devices 128 through bus cable 124, which can include a male (or female) connector 508. The connector 508 can be received by, and connect with, any of sensor input connectors 308. The sensor 104 can include a processing circuit configured to perform flame detection based on sensor signals. For example, the processing circuit can include firmware for processing any of the sensor signals to determine if a fire or a fire condition is present at the area of interest.

One or more components, devices, devices, sensors, etc., of the system 100 can be plug-and-play devices. This can facilitate easy installation, removal, and replacement of the various components of the system 100. The sensor signals received from sensors 104 can be provided to the controller 108. The controller 108 can include a memory and can generate logs. The logs can be accessed from controller 108 via a communications port. The logs include fire detection information (e.g., times at which sensors 104 detected a fire or a fire condition). A technician can troubleshoot faults in the system 100 by examining the light output devices 320 of the interface device 120 and/or interface expansion device 128.

The controller 108 can operate the discharge system 208 to provide fire suppressant agent to the area of interest (the monitored area) to suppress the fire. The controller 108 can operate the discharge system 208 to provide fire suppressant agent to the area of interest in response to one or more of sensors 104 detecting a fire or a fire condition.

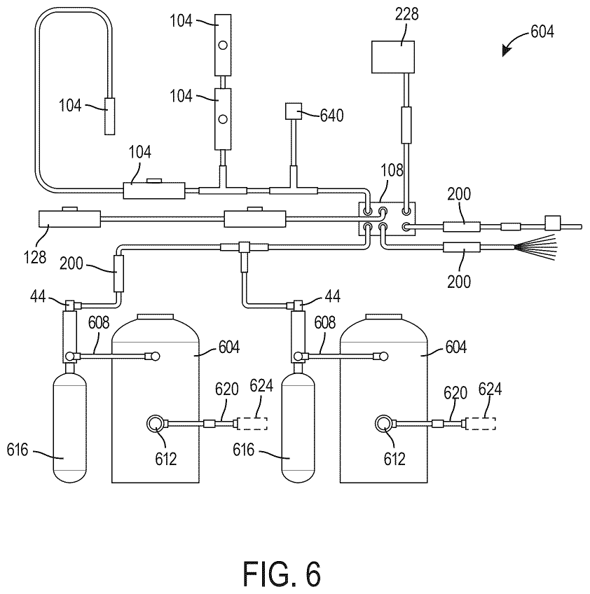

FIG. 6 depicts an example of the discharge system 208. The discharge system 208 can be a chemical fire suppression system. The discharge system 208 can dispense or distribute a fire suppressant agent onto and/or nearby a fire, extinguishing the fire and preventing the fire from spreading. The discharge system 208 can be used alone or in combination with other types of fire suppression systems (e.g., a building sprinkler system, a handheld fire extinguisher, etc.). A plurality of discharge systems 42 can be used in combination with one another to cover a larger area (e.g., each in different rooms of a building).

The discharge system 208 can be used in a variety of applications. For example, various applications can have differing suppression criteria, such as to require different types of fire suppressant agent and different levels of mobility. The discharge system 208 can be usable with a variety of different fire suppressant agents, such as powders, liquids, foams, or other fluid or flowable materials. The discharge system 208 can be used in a variety of stationary applications. By way of example, the discharge system 208 can be usable in kitchens (e.g., for oil or grease fires, etc.), in libraries, in data centers (e.g., for electronics fires, etc.), at filling stations (e.g., for gasoline or propane fires, etc.), or in other stationary applications. The discharge system 208 can be used in a variety of mobile applications. For example, the discharge system 208 can be incorporated into land-based vehicles (e.g., racing vehicles, forestry vehicles, construction vehicles, agricultural vehicles, mining vehicles, passenger vehicles, refuse vehicles, etc.), airborne vehicles (e.g., jets, planes, helicopters, etc.), or aquatic vehicles, (e.g., ships, submarines, etc.).

The discharge system 208 can include one or more fire suppressant tanks 604 (e.g., vessels, containers, vats, drums, tanks, canisters, cartridges, cans, etc.). The fire suppressant tank 604 can be filled (e.g., partially, completely, etc.) with fire suppressant agent. The fire suppressant agent may normally not be pressurized (e.g., is near atmospheric pressure). The fire suppressant tank 604 can include an exchange section, shown as a hose 608 and an outlet section (e.g., an aperture, a valve, etc.), shown as an outlet valve 612. The hose 608 can allow the flow of expellant gas into fire suppressant tank 604 and the flow of fire suppressant agent out of fire suppressant tank 604 through the outlet valve 612 so that the fire suppressant agent can be supplied to a fire or a fire condition.

The discharge system 208 can include at least one cartridge 616 (e.g., a vessel, container, vat, drum, tank, canister, cartridge, or can, etc.). The cartridge 616 can have a volume of pressurized expellant gas. The expellant gas can be an inert gas. The expellant gas can be air, carbon dioxide, or nitrogen. The cartridge 616 can be rechargeable or disposable after use.

As depicted in FIG. 2, the discharge system 208 can include at least one actuator 212 (e.g., a valve, puncture device, or activator assembly). The actuator 212 can selectively couple the cartridge 616 with the fire suppressant tank 604 to facilitate activation of the discharge system 208. Decoupling the cartridge 616 from the actuator 212 may facilitate removal and replacement of the cartridge 616 responsive to the cartridge 616 being depleted and/or in a depleted state.

Responsive to the actuator 212 being activated and the cartridge 616 being fluidly coupled with the hose 608, the expellant gas from the cartridge 616 can flow (e.g., flow freely) through the hose 608. The expellant gas can force fire suppressant agent from fire suppressant tank 604 out through the outlet valve 612 and into a pipe 620 (e.g., conduit or hose). The hose 608 directs the expellant gas from cartridge 616 to fire suppressant tank 604 (e.g., to a top portion of fire suppressant tank 604). The pressure of the expellant gas within the fire suppressant tank 604 can force the fire suppressant agent to exit through the outlet valve 612. The discharge system 208 can be structured such that the expellant gas enters a bladder within the fire suppressant tank 604, and the bladder presses against the fire suppressant agent to force the fire suppressant agent out through the outlet valve 612. The fire suppressant tank 604 can include a burst disk that prevents the fire suppressant agent from flowing out through the hose 608 until the pressure within fire suppressant tank 604 exceeds a threshold pressure. Responsive to the pressure exceeding the threshold pressure, the burst disk can rupture, which can allow for the flow of fire suppressant agent. The fire suppressant tank 604 can include a valve, a puncture device, or another type of opening device or activator assembly that can fluidly couple the fire suppressant tank 604 with the pipe 620 in response to the pressure within fire suppressant tank 604 exceeding the threshold pressure. Such an opening device can be configured to activate mechanically (e.g., the force of the pressure causes the opening device to activate, etc.), fluidly (e.g., using a pressurized liquid or gas), or electrically (e.g., in response to receiving an electrical signal from a controller). The opening device may include a separate pressure sensor in communication with fire suppressant tank 604 that causes the opening device to activate. The actuator 212 can activate in response to receiving an electrical signal from the controller 108.

The pipe 620 can be fluidly coupled with one or more nozzles 624 (e.g., outlets or sprayers). The fire suppressant agent flows through the pipe 620 and to nozzles 624. The nozzles 624 each define one or more apertures, through which the fire suppressant agent exits, forming a spray of fire suppressant agent that covers a desired area. The sprays from nozzles 624 can suppress or extinguish fire within that area. The apertures of the nozzles 624 can be shaped to control the spray pattern of the fire suppressant agent from the nozzles 624. The nozzles 624 can be aimed such that the sprays cover specific points of interest (e.g., a specific piece of restaurant equipment, a specific component within an engine compartment of a vehicle, etc.). The nozzles 624 can all be activated simultaneously, or nozzles 624 can be activated selectively (e.g., in a region around the fire).

The discharge system 208 can use the manual activation device 204 that controls the activation of the actuator 212. The manual activation device 204 can activate the actuator 212 in response to an input from an operator. The manual activation device 204 can be included instead of or in addition to the controller 108. The controller 108 and the manual activation device 204 can activate the actuator 212 independently. By way of example, the controller 108 can activate actuator 212 regardless of any input from the manual activation device 204, and vice versa.

The actuator 212 can activate in response to receiving an electrical signal from the manual activation device 204. As depicted in FIG. 6, the manual activation device 204 can include a button 640 to provide a control signal to the controller 108. By way of example, controller 108 can be configured to monitor a signal from button 640 to determine that the button 640 is pressed. Responsive to detecting that the button 640 has been pressed, the controller 108 can transmit a control signal to the actuator 212 to activate the actuator 212.

The controller 108 can monitor the status of and output information to the user interface device 228. Responsive to determining that the user interface device 228 is engaged (e.g., is in an operational state; has received a status request), the controller 108 can provide electrical signals to the user interface device 228. By way of example, the controller 108 can receive a first electrical signal from either manual activation device 204 or sensors 104 that the button 640 has been pressed or the temperature has reached the threshold temperature (or that a fire or a fire condition has optically been detected). In response to the first electrical signal, a second electrical signal can be sent from controller 108 to the user interface device 228. The second electrical signal can be used to present an alert to a user by way of a notification device (e.g., an LED, an auditory signal, etc.) on the user interface device 228.

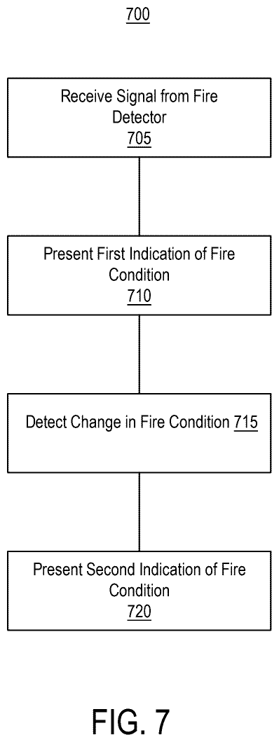

FIG. 7 depicts an example of a method 700. The method 700 can be performed by one or more systems or devices described herein, such as the system 100.

At 705, a signal can be received from one or more fire detectors. For example, the signal can be received from one or more sensors that detect fire conditions, such as optical sensors, such as infrared sensors. The signal can be processed to determine that a fire condition is present. For example, a signal from an infrared sensor can indicate that the fire condition is present and/or indicate at least one of a wavelength of light and a temperature, which can be evaluated relative to one or more thresholds to determine that the fire condition is present.

At 710, a first indication of the fire condition can be presented. For example, responsive to detecting that the fire condition is present, the first indication can be presented as a flashing light (e.g., light output that changes in intensity by a predetermined threshold amount to be perceived by a user and/or turns on/off, at a rate on the order of seconds or fractions of seconds (e.g., a rate greater than once every ten seconds and less than once every 1 millisecond, such as a predetermined rate expected to be perceivable by a user). The light(s) that is flashed can be a light on an interface device that is mapped to the fire detector(s) from which the signal indicating that the fire condition is present can be received.

At 715, a change in the fire condition can be detected. For example, the signal from the fire detector can be monitored to detect a different value and/or a change in a value represented by the signal and/or a discontinuation of the signal. The signal can be periodically processed to detect that the fire condition is not present (e.g., temperature has decreased below a threshold; wavelength of light detected is no longer consistent with a temperature that indicates a fire condition and/or flame is present).

At 720, a second indication of the fire condition can be presented responsive to the change in the fire condition. For example, the second indication can include a different mode or pattern of light output, such as to present the light output as a solid light (e.g., compared with flashing light).

The second indication can be latched, e.g., maintained in the second mode of presenting the second indication (or otherwise maintained on to indicate that a fire condition had been detected), until a delatching condition is satisfied. The delatching condition can include receipt of a user input (e.g., via a reset button) indicating instructions to discontinue presenting the second indication. The delatching can include a change in a power state of the interface device to cause the light output to be terminated.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”)are merely used to describe the orientation of various elements in the FIGURES. It should be noted that the orientation of various elements may differ according to other exemplary embodiments, and that such variations are intended to be encompassed by the present disclosure.

What is claimed is:

1. A fire suppression system, comprising:
a sensor to output a status signal;
an interface device comprising:
a light emitting device (LED); and
one or more processors to:
cause, based on the status signal indicating a normal condition, the LED to display a first color of light;
cause, based on the status signal indicating a fire condition, the LED to display a second color of light; and
cause, based on the status signal indicating a fault, the LED to display a third color of light and to maintain the third color of light subsequent to a change of the status signal from indicating the fault;
a controller to output an activation signal based on the status signal indicating the fire condition; and
an actuator to cause a fire suppressant agent to be outputted to suppress the fire condition based on the activation signal.

2. The fire suppression system of claim 1, comprising:
an interface expansion device coupled with the interface device;
a second sensor coupled with the interface expansion device;
the interface device comprising a second LED; and
the one or more processors to control operation of the second LED according to a second status signal, from the interface expansion device, regarding the interface expansion device or the second sensor.

3. The fire suppression system of claim 1, comprising:
the sensor comprises an optical sensor.

4. The fire suppression system of claim 1, comprising:
a wired connection from the sensor to the interface device.

5. The fire suppression system of claim 1, comprising:
the interface device comprises a reset button; and
the one or more processors are to cause the LED to maintain the display of the third color until a press of the reset button.

6. The fire suppression system of claim 1, comprising:
an interface expansion device coupled with the interface device; and
the one or more processors to cause at least one of the LED or a second LED to display a color corresponding to a second status signal received from the interface expansion device.

7. The fire suppression system of claim 1, comprising:
the controller is to generate a log of the fire condition.

8. A fire suppression system, comprising:
one or more fire detectors to output a signal to indicate that a fire condition is present;
a controller to control operation of one or more actuators to cause a fire suppressant to be outputted to address the fire condition;
an interface device comprising one or more processors to:
receive the signal from the one or more fire detectors;
output a first alarm responsive to the signal indicating that the fire condition is present;
transmit an alarm signal, along a wired connection with the controller, responsive to receiving the signal from the one or more fire detectors; and
output a second alarm responsive to an indication that the fire condition is not present; and
an actuator to cause a fire suppressant agent to be outputted to suppress the fire condition responsive to a control signal from the controller.

9. The fire suppression system of claim 8, comprising:
the one or more processors are to perform an electronic latching of the output of the second alarm responsive to initiation of the second alarm, the second alarm having a solid state and the first alarm having a flashing state.

10. The fire suppression system of claim 8, comprising:
the one or more fire detectors comprise an infrared sensor, the infrared sensor to output the signal responsive to detecting a flame of the fire condition.

11. The fire suppression system of claim 8, comprising:
the one or more processors are to periodically monitor the signal from the one or more fire detectors and transition from the first alarm to the second alarm responsive to detecting a transition in the signal from indicating that the fire condition is present to indicating that the fire condition is not present.

12. The fire suppression system of claim 8, comprising:
the first alarm comprises a first pattern of light output, and the second alarm comprises a second pattern of light output having at least a different intensity or a different intermittency than the first pattern of light output.

13. The fire suppression system of claim 8, comprising:
the one or more processors are to output the first alarm responsive to detecting, based on the signal, that the fire condition is present for at least a threshold amount of time.

14. The fire suppression system of claim 8, comprising:
the one or more processors are to output the second alarm responsive to at least one of:
discontinuation of reception of the signal from the one or more fire detectors; and
reception of a signal from the one or more fire detectors indicative of the fire condition not being present.

15. A fire detection system, comprising:
a fire detector to detect a fire condition and output a signal representative of the fire condition being present; and
an alarm device comprising one or more processors to:
receive the signal representative of the fire condition;
cause at least one light output device to present, in a first mode associated with the fire condition being present, a first indication of the fire condition; and
cause the at least one light output device to present, in a second mode that is subsequent to the first mode and associated with the fire condition not being present, a second indication of the fire condition, the second indication different from the first indication.

16. The fire detection system of claim 15, comprising:
the fire detector comprises an infrared sensor.

17. The fire detection system of claim 15, comprising:
the alarm device comprises a communication interface to transmit an indication of the fire condition being present to a controller of a fire suppression system.

18. The fire detection system of claim 15, comprising:
the first indication of the fire condition comprises a first pattern of light output, and the second indication of the fire condition comprises a second pattern of light output.

19. The fire detection system of claim 15, comprising:
the one or more processors are to operate the light output device in the first mode responsive to detecting, based on the signal representative of the fire condition, that the fire condition is present for at least a threshold amount of time.

20. The fire detection system of claim 15, comprising:
the one or more processors are to operate the light output device in the second mode responsive to at least one of:
discontinuation of reception of the signal representative of the fire condition from the fire detector; and
reception of a signal from the fire detector indicative of the fire condition not being present.
